(19) United States
(12) Patent Application Publication
(10) Pub. No.: US 2021/0382866 A1
(43) Pub. Date: Dec. 9, 2021

(54) RESOURCES AND METHODS FOR TRACKING PROGRESSION IN A LITERARY WORK

(71) Applicant: Arm IP Limited, Cambridge, MA (US)

(72) Inventor: Sanne WOUDA, Cambridge (GB)

(21) Appl. No.: 17/288,158

(22) PCT Filed: Oct. 14, 2019
(86) PCT No.: PCT/GB2019/052928

§ 371 Date: Apr. 23, 2021

(30) Foreign Application Priority Data
Nov. 6, 2018 (GB) 1818088.5

(51) Int. Cl. G06F 16/22; G06F 16/25; G06F 16/21

(52) U.S. Cl. CPC G06F 16/2255; G06K 9/00469; G06F 16/219; G06F 16/258

(57) ABSTRACT

The present techniques generally relate to an apparatus for determining user progression data in a literary work, the apparatus comprising: a database comprising formatted literary data for two or more versions of a literary work; and circuitry to: process tracker position data for a first version of the one or more versions; and determine, from formatted literary data for the two or more versions, progression data for a second version of the literary work based on or in response to the tracker position data for the first version.

The present techniques generally relate to systems, methods and devices for tracking user progression through one or more literary works such as books, journals, magazines and the like.

There are ever increasing numbers of data processing devices having processing and communication capabilities, which allows for interaction between such data processing devices, objects and services, across different environments, for example, as part of the ‘Internet of Things’ (IoT).

The present techniques seek to provide improvements over the prior art.

According to a first technique there is provided an apparatus for determining user progression data in a literary work, the apparatus comprising: a database comprising formatted literary data for two or more versions of a literary work; and circuitry to: process tracker position data for a first version of the one or more versions; and determine, from formatted literary data for the two or more versions, progression data for a second version of the literary work based on or in response to the tracker position data for the first version.

According to a further technique there is provided a method of determining user progression in a literary work, the method comprising: processing, at a first apparatus, tracker position data for a first version of a literary work; determining, from formatted literary data for two or more versions of the literary work, progression data for a second version based on or in response to the tracker position data for the first version.

According to a further technique there is provided a method of tracking user progression in a literary work, the method comprising: generating, at a first apparatus, tracker position data comprising sensed data relating to a position in a first version of a literary work; transmitting, from the first apparatus to a second apparatus, the tracker position data; receiving, at the first apparatus, progression data for a second version determined based on or in response to the tracker position data; causing output circuity to output a formatted position for the second version based on or in response to the progression data.

According to a further technique there is provided a tracker device for determining user progression data in a literary work, the tracker device comprising circuitry to: store formatted literary data for two or more versions of a literary work; generate sensed data relating to a position in a first version of the literary work; and determine, from the formatted literary data, progression data for a second version of the literary work based on or in response to the sensed data, wherein one of the first version and the second version is a physical version of the literary work.

According to a further technique there is provided a tracker device for tracking user progression data in a physical version of a literary work, the tracker device comprising circuitry to: generate sensed data relating to a position in the physical version; and output data based on or in response to the sensed data.

According to a further technique there is provided a literary work comprising an apparatus of any of claims 1 to 13.

According to a further technique there is provided a non-transitory computer readable storage medium comprising code which when implemented on a processor causes the processor to carry out the method of any one of claims 14 to 21.

The present techniques are diagrammatically illustrated, by way of example, in the accompanying drawings, in which:

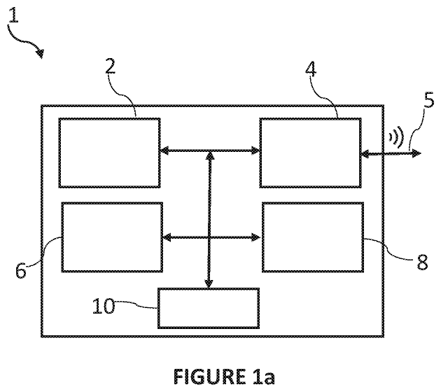

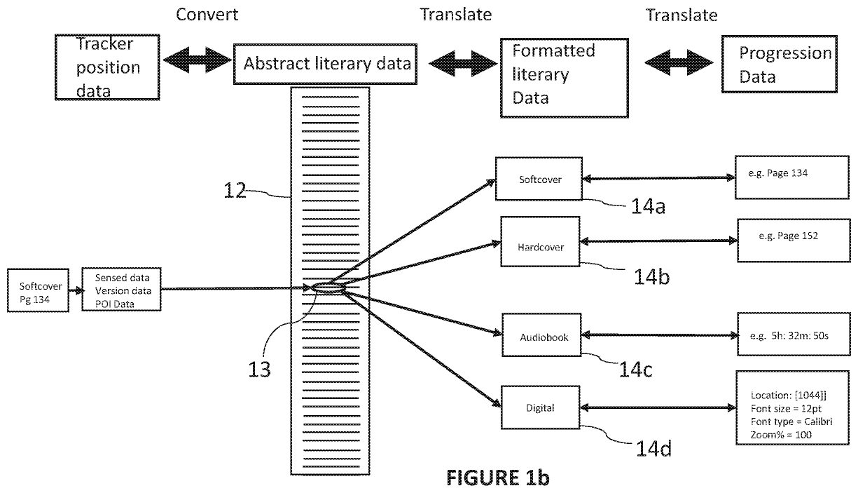

FIG. 1a illustratively shows a block diagram of a tracker device;

FIG. 1b illustratively shows an example of generating progression data for different versions of a literary work;

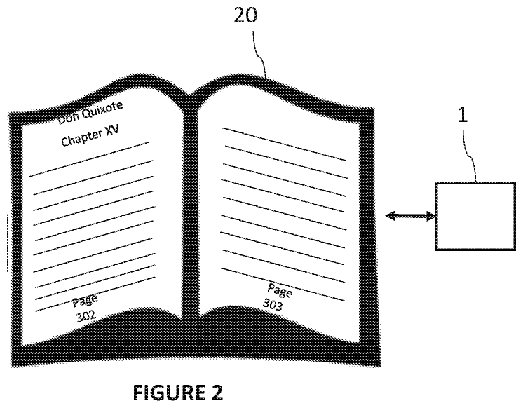

FIG. 2 illustratively shows a tracker device and a literary work;

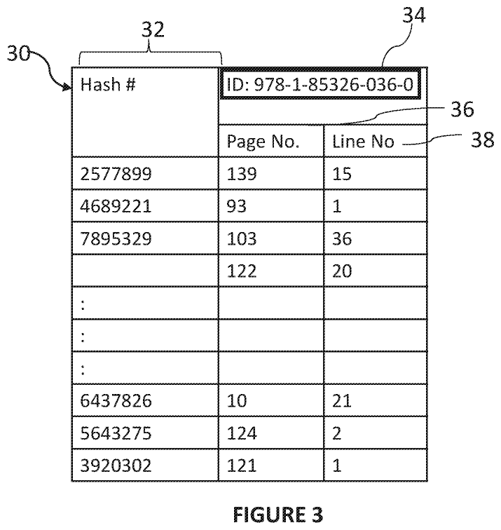

FIG. 3 illustratively shows a database according to an embodiment;

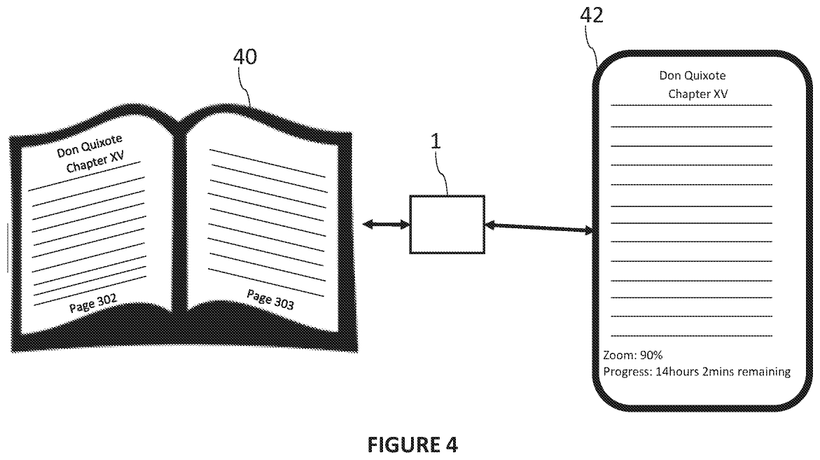

FIG. 4 illustratively shows the tracker device and a plurality of literary works;

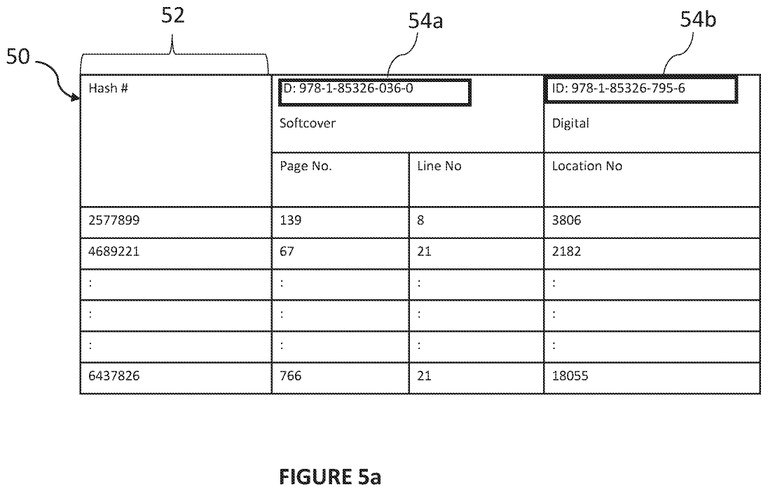

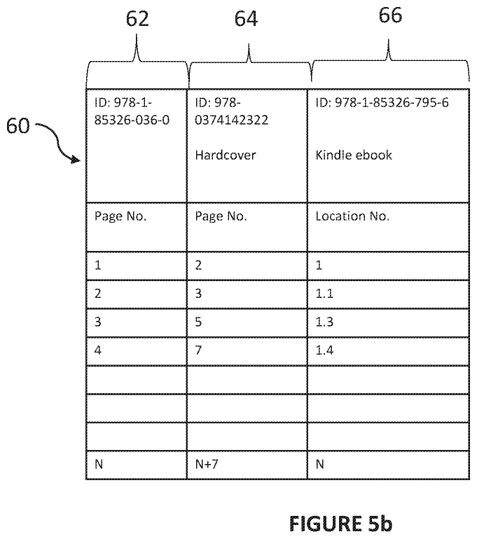

FIGS. 5a and 5b illustratively shows examples of databases;

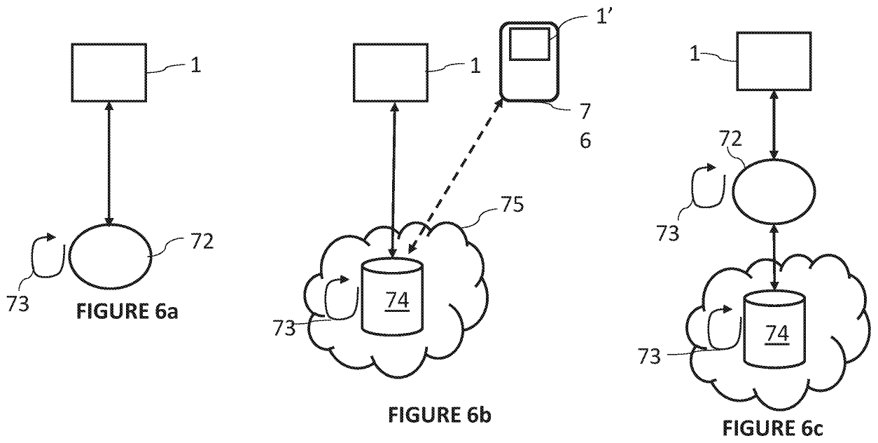

FIGS. 6a to 6c illustratively show examples of tracker device in communication with one or more resources;

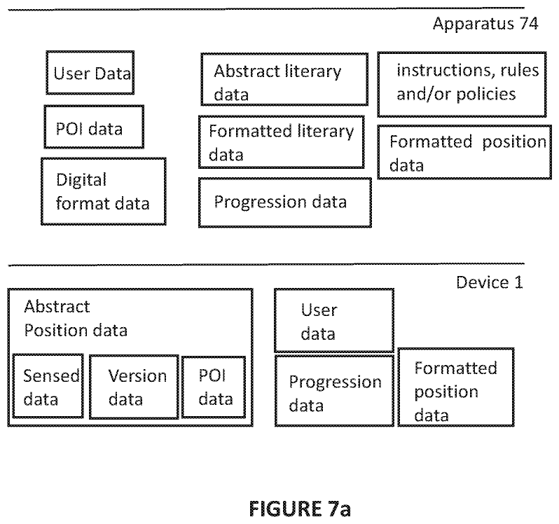

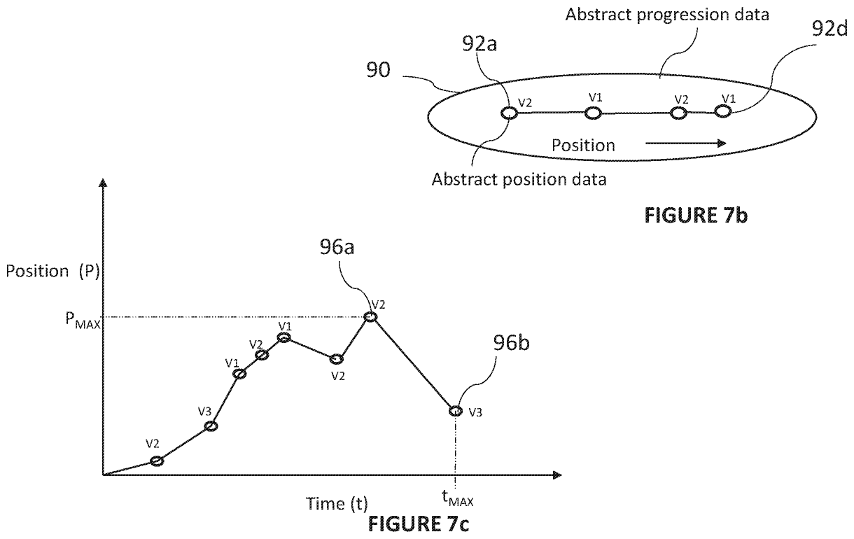

FIG. 7a illustratively shows a block diagram showing example data of the tracker device and apparatus;

FIG. 7b illustratively shows an example data structure representative of progression through a literary work;

FIG. 7c illustratively shows a further example data structure representative of progression through a literary work;

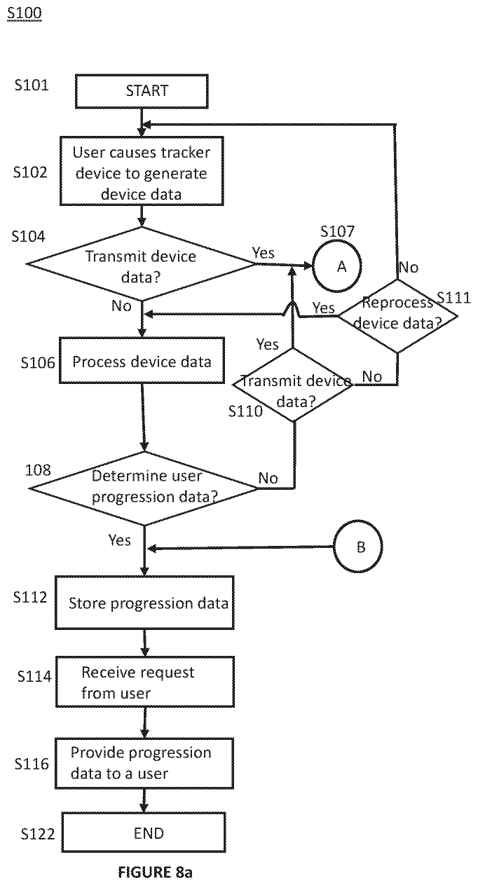

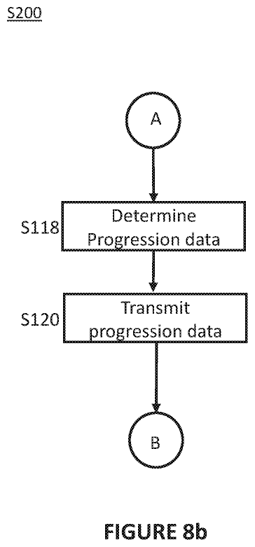

FIG. 8a illustratively shows a flow diagram of a process in which tracker device generates device data from which progression data is determined; and

FIG. 8b illustratively shows a flow diagram of a process in which a resource receives device data from the tracker device.

The present techniques generally relate to an apparatus which determines progression data for one or more versions or instances (hereafter “versions”) of a literary work, such as a book (physical or digital book), a magazine (e.g. physical or online), journals (physical, online, digital book) etc. It will be appreciated that this list of literary works is exemplary only and the claims are not limited in this respect. It will be appreciated a physical version of a literary work will be understood to be a non-digital version, having physical pages on which text/pictures are printed, such as a printed hardback version or a printed softback version of a book, magazine or journal.

As described herein, progression data may relate to a position in a literary work, whereby such a position may be one or more of: a line number, a paragraph number, a page number, a chapter number, an appendix number, an edition number, and a volume number, although this list is exemplary only and the claims are not limited in this respect.

Additionally, or alternatively, the present techniques provide for the synchronisation of the progression data across different versions of the same literary works (e.g. between a physical book and digital book and/or between different editions of a physical book).

The present techniques are described more fully hereinafter with reference to the accompanying drawings. Like numbers refer to like elements throughout.

FIG. 1a illustratively shows a block diagram of an apparatus, which in the present illustrative example is a tracker device 1, which may be a resource in the Internet of Things (IoT) and which may be used to determine progression data or which may be used to transmit device data to an apparatus or resource remote therefrom (hereafter ‘apparatus’) to enable the apparatus to determine the progression data.

Tracker device 1 comprises processing circuitry 2, such as a microprocessor or integrated circuit(s) for processing data and for controlling various operations performed by the tracker device 1.

The tracker device 1 also has communication circuitry 4 for communicating with one or more apparatuses remote therefrom such as a computer terminal, mobile device, gateway device (not shown), service etc. Such a service may comprise a public cloud service (e.g. where the service operates in a public cloud infrastructure); a private cloud service (e.g. where the service operates on private cloud infrastructure); on-premise service (e.g. where the service is hosted on a private infrastructure); and a hybrid cloud service (e.g. a combination of the public, private and on-premise services).

The communication circuitry 4 may use wireless communications 5, such as communications used in, for example, wireless local area networks (WLAN) and/or wireless sensor networks (WSN) such as Wi-Fi®, Thread®, ZigBee®, Bluetooth®, Bluetooth Low Energy® (BLE), LoRA®, NB-IoT, etc., using any suitable communications protocol such as lightweight machine-to-machine (LWM2M). The communication circuitry 4 may also comprise short range communication capabilities such as radio frequency identification (RFID) or near field communication (NFC).

The tracker device 1 also comprises storage circuitry 6 (e.g. non-volatile/volatile storage), for storing data provisioned on or generated thereby, hereafter “device data”.

Such device data may include one or more device identifiers to identify the tracker device 1, which may comprise one or more of: universally unique identifier(s) (UUID), globally unique identifier(s) (GUID) and IPv6 address(es), although any suitable device identifier(s) may be used.

The device data may also include authentication data for establishing trust/cryptographic communications between the tracker device 1 and a remote apparatus. Such authentication data may include certificates (e.g. signed by a root authority), cryptographic keys (e.g. public/private keys; symmetric key pairs), tokens etc. The authentication data may be provisioned on the tracker device 1 by any authorised party (e.g. by an owner, a manufacturer, or an installer).

The tracker device 1 may also be provisioned with or comprise circuitry to generate other device data from which progression data may be determined.

For example, the tracker device 1 may comprise input/output (I/O) circuitry 8 to generate sensed data for a version of a literary work, from which progression data for the particular version can be determined.

As an illustrative example the I/O circuitry 8 comprises sensor circuitry to generate sensed data which relates to a position in a particular version of a literary work, whereby such sensor circuitry may include a camera; a barcode reader; a weight sensor; a microphone although the claims are not limited in this respect.

The I/O circuitry 8 may also receive an input from a user. As an illustrative example, the input may be via one or more buttons. In illustrative examples, the one or more buttons may define prestored commands which the tracker device 1 will perform when pressed. In other illustrative examples the I/O circuitry 8 may comprise a keyboard (e.g. via a display).

The I/O 8 circuitry may also comprise output circuitry to generate a sensory output for a user, whereby the output circuit may include one more of a light, a display (e.g. e-ink, LCD, OLED etc.), a speaker, a braille terminal etc.

The tracker device 1 also comprises power circuitry 10 to power the various circuitry and components therein. In examples, the power circuitry 10 comprises a battery. Additionally, or alternatively, the power circuitry may comprise an energy harvester (e.g. Wi-Fi harvester), which may be used to power the various circuitry and components and/or to charge the battery.

In some embodiments the tracker device 1 may be a standalone device, whereby, as an illustrative example, the tracker device 1 may be in the shape of a traditional bookmark having a planar body which can be inserted between pages of a physical book, although the claims are not limited in this respect.

In some embodiments the tracker device may be associated with an object to transform the object into a smart object (e.g. by attachment or incorporation into the object). As an illustrative example, a pen may be transformed into a smart pen by providing the features of a tracker device therein.

As a further illustrative example, a tracker device may be incorporated into a physical book or journal, for example whereby the circuitry may be provided in the spine of the book, although the claims are not limited in this respect.

Alternatively, a mobile apparatus such as a mobile phone, tablet, digital book etc. may be configured to provide the functionality of the tracker device 1 described herein. For example, a user may download and run an application providing the functionality of the tracker device thereon.

The tracker device 1 may, using device data stored and/or generated thereat determine progression data for one or more versions of a literary work. In other embodiments the tracker device may transmit the device data to a remote apparatus for determination of the progression data at the apparatus.

The tracker device 1 may then perform an action based on or in response to determining the progression data, or in response to a command communication from an apparatus as will be described in greater detail.

FIG. 1b illustratively shows an example of how the tracker device may determine progression data based on or in response to tracker position data.

As depicted in FIG. 1b the tracker device may comprise abstract literary data 12 for one or more literary works, whereby, the abstract literary data 12 is data which is not structured or formatted for any particular version of the one or more literary works. In examples, the abstract literary data 12 may comprise all characters of a literary work, stored, for example, as a consecutive block or stream of characters. A particular position 13 in the abstract literary data (e.g. corresponding to one or more words, chapter numbers, paragraph numbers etc.) is hereafter referred to as an “abstract position”.

The tracker device 1 may translate some or all of the abstract literary data into formatted literary data for one or more versions of a literary work, whereby the formatted literary data for a particular version defines the structure or formatting of the characters within the particular version such that the tracker device can determine a position within a particular version of literary work (hereafter “formatted position”) from the abstract position data.

As an illustrative example, the tracker device can translate abstract position 13 (e.g. a word) to a formatted position for the word in the particular version. The tracker device may use instruction(s), rule(s) and/or policy(ies) in storage to translate the abstract position data of the abstract literary data into formatted position data for one or more versions.

Formatted literary data 14a-14d for four different versions of a literary work is depicted in FIG. 1b, whereby the version depicted at 14a is a softcover version of the literary work; the version depicted at 14b is a softcover version of the literary work; the version depicted at 14c is an audiobook version of the literary work; the version depicted at 14d is a digital or eBook version of the literary work. It will be appreciated that claims are not limited in the number or type of versions for which formatted literary data can be generated.

As shown in the illustrative example of FIG. 1b a user may cease reading a softcover version of a literary work and generates tracker position data related to that position (depicted as pg. 134). The tracker device then converts the tracker position data to an abstract position 13. The tracker device then translates the abstract position to formatted positions in each of the versions 14a-14d, and the progression data for each version determined to be the formatted positions for the respective versions. As such the progression data is determined from the formatted literary data based on or in response to tracker position data generated at one or more tracker devices, whereby as will be described in greater detail below, the tracker position data may comprise, for example one or more of: version data and sensed data.

The tracker device 1 may store the progression data for the one or more versions in storage. When subsequently requested by the user, the tracker device may then provide the determined progression data to a user in a user understandable format (e.g. on a display, via a speaker, a braille terminal etc.)

In some examples, the tracker device may store formatted literary data for one version of a literary work and may translate the progression data determined for that version of literary work into progression data for one or more further literary works. When a user ceases reading a first version of a literary work and causes the tracker device to generate tracker position data (e.g. for the page at which the user stopped reading), the tracker device will determine the progression data (e.g. formatted position data) for the first version. When the user subsequently begins reading a second version of literary work the tracker device will determine the progression data, such as formatted position data, for the second version and convert the formatted position data in to a user understandable format (e.g. on a display). Such functionality provides for synchronisation of the progression data for two or more versions of a literary work.

The tracker device may further comprise digital format data, which may comprise instruction(s), rule(s) and/or policy(ies) to enable the tracker device to format the formatted position data for different digital devices which the user is using so as to be able to display the formatted position dependent on, for example, the device type, screen size of the device, font size used, font type used etc.

In some embodiments the tracker device 1 may be provisioned with the formatted literary data for a particular literary work and may further be provisioned with instruction(s), rule(s) and/or policy(ies) as to how to convert the tracker position data to the formatted position data, so the tracker device does not have to perform the translation from the abstract literary data to the formatted literary data. Such functionality may be especially useful for constrained tracker devices with limited processing and storage capabilities.

In embodiments the sensed data may be generated by sound sensor circuitry. As an illustrative example, the tracker device 1 may capture, via audio sensor circuitry (e.g. comprising a microphone), a voice recording of the user reading one or more characters (e.g. a page number or a portion of text). The tracker device 1 may then process the recording (e.g. using speech recognition software (SRS)) to convert the recording into sensed data comprising machine-encoded text.

The machine encoded text can be can be converted to an abstract position in the abstract literary work. The abstract position may be translated to a formatted position in the formatted literary data for one or more versions of the literary work, the formatted position data for a particular version determined to be progression data for that particular version (e.g. page number (for a physical version), location number (for a digital version), audio time (for audiobook version) etc. As such, the tracker device 1 can determine progression data from the formatted literary data for different versions based on or in response to the sensed data from one version.

As a further illustrative example, the user may flick or rifle though the pages of the literary work, starting the rifling action from the page at which the user ceased reading to a set point in the literary work (e.g. to the front or back cover), whereby audio sensor circuitry on the tracker device records the resulting sound waves as sensed data. The tracker device 1 may then process the recording to determine progression data from the formatted literary data based on or in response to the characteristics of the sensed sound waves. For example, the length of the recorded sound waves can be converted to a known number of pages and that number of pages corresponding to an abstract position in the abstract literary data.

The abstract position may be translated to a formatted position in the formatted literary data for one or more versions of the literary work, the formatted position data for a particular version determined to be progression data for that particular version.

Alternatively, the frequency of the sound waves can be can be converted to an abstract position in the abstract literary data for a literary work, which may be translated to a formatted position in the formatted literary data for one or more versions.

As a further illustrative example, an object (e.g. the tracker device itself) can be dragged along the outside edge of the pages of the literary work, starting the dragging action from the page at which the user ceased reading to a set point, whereby audio sensor circuitry on the tracker device records the resulting sound waves as sensed data. As above, the recording may be converted to an abstract position which may be translated to a formatted position in the formatted literary data for one or more versions of the literary work, the formatted position data for a particular version determined to be progression data for that particular version.

As a further illustrative example, the sensed data may be generated by electrical sensor circuitry. As an illustrative example, the sensor circuitry may comprise a material whose electrical characteristics (e.g. resistance, conductivity etc) are a function of the shape thereof. When a user ceases reading the literary work, the user may bend or wrap the resistive portion around a portion of the literary work, for example, from the page at which the user ceased reading to a set point in the literary work (e.g. to the front or back cover), such that the electrical characteristics can be measured as sensed data. The tracker device 1 may then determine progression data from the formatted literary data based on or in response to the sensed data. For example, the measured resistance or conductivity can be converted to a known number of pages, and that number of pages corresponding to an abstract position in the abstract literary data.

The abstract position may be translated to a formatted position in the formatted literary data for one or more versions of the literary work, the formatted position data for a particular version determined to be progression data for that particular version.

In a further illustrative example, the pages of the literary work may be conductive, or each page may have a conductive portion provided thereon (e.g. printed), such that the conductive portions on adjacent pages are in electrical communication with each other when closed with respect to one another to provide, in effect, a printed wire through the closed pages of the literary work. As such, when a user ceases reading the literary work, the user may measure an electrical characteristic (e.g. electrical resistance or electrical conductivity) of the literary work from the page at which the user ceased reading to a set point in the literary work (e.g. to the front or back cover) such that the electrical characteristics can be measured as sensed data. The tracker device 1 may then determine progression data from the formatted literary data based on or in response to the sensed data. For example, the measured resistance or conductivity can be converted to a known number of pages, and that number of pages corresponding to an abstract position in the abstract literary data.

The abstract position may be translated to a formatted position in the formatted literary data for one or more versions of the literary work, the formatted position data for a particular version determined to be progression data for that particular version.

In a further illustrative example, the literary work may comprise components for generating electromagnetic energy (e.g. an NFC tag, RFID tag) provided, for example, at a set point at the literary work (e.g. such as attached to or embedded into the front and/or rear cover). The tracker device can then measure the electromagnetic energy as sensed data. The tracker device 1 may then determine progression data from the formatted literary data based on or in response to the sensed data, whereby, for example, the measured strength of the electromagnetic energy can be converted to a known number of pages from the set point, and that number of pages corresponding to an abstract position in the abstract literary data.

The abstract position may be translated to a formatted position in the formatted literary data for one or more versions of the literary work, the formatted position data for a particular version determined to be progression data for that particular version.

In a further illustrative example, the sensed data may be generated by weight sensor circuitry, whereby the tracker device 1 may comprise a strain gauge, and whereby when a user ceases reading the literary work, the user may place tracker device 1 into the literary work at the page the user ceased reading and close the literary work, whereby a weight sensor records the resulting weight of the pages as sensed data. The tracker device 1 may then determine progression data from the formatted literary data based on or in response to the sensed data, whereby, for example, the measured weight can be converted to a known number of pages for a particular version, and that number of pages corresponding to an abstract position in the abstract literary data.

The abstract position may be translated to a formatted position in the formatted literary data for one or more versions of the literary work, the formatted position data for a particular version determined to be progression data for that particular version.

In embodiments the sensed data may be generated by a camera sensor circuitry to detect physical features provided on or in the literary work or associated therewith.

In an illustrative example, such physical features may comprise one or more codes printed or impressed on a page, whereby a sensor or reader may detect the codes and determine the progression data therefrom. In an illustrative example, the code may comprise a barcode (e.g. QR code) or a series of microdots unique for a page/chapter etc, whereby a sensor detects the code as sensed data and determines the progression data therefrom. For example, the sensed code may relate to a particular page of a particular physical version, and that pages corresponding to an abstract position in the abstract literary data.

The abstract position may be translated to a formatted position in the formatted literary data for one or more versions of the literary work, the formatted position data for a particular version determined to be progression data for that particular version.

In a further illustrative example, the physical features may comprise one or more characters printed on a page. The one or more characters may comprise a chapter number, paragraph number or page number, whereby the tracker device 1 may capture the printed characters as an image with the camera (e.g. as a JPEG) and store the image in a non-volatile memory as sensed data.

Additionally, or alternatively, the tracker device 1 may process the image to convert the text in the images into further sensed data comprising machine-encoded text (e.g. using optical character recognition (OCR)). The tracker device 1 can then identify matching text as an abstract position in the abstract literary work.

The abstract position may be translated to a formatted position in the formatted literary data for one or more versions of the literary work, the formatted position data for a particular version determined to be progression data for that particular version.

For a digital version of a literary work, the sensed data may correspond to text displayed on a screen of the device. For example, the sensed data may comprise a screenshot image of the text, or a location number generated by the device itself. The tracker position data from the digital device may include version data comprising a version identifier for the digital literary work, a device identifier for the device on which the user is reading (e.g. Model Number/type), and may further include details of the device parameters/settings (e.g. font size, font type, % zoom) implemented on the digital device at the time the user generated the sensed data.

The tracker device may determine an abstract position from the sensed data and the abstract position may be translated to a formatted position in the formatted literary data for one or more versions of the literary work, the formatted position data for a particular version determined to be progression data for that particular version.

In embodiments, the tracker device 1 may store the determined progression data in storage such that when the user requests the progression data such as where he last paused reading (e.g. by pressing a button on the tracker device), the tracker device 1 can provide the progression data to the user, whereby, for example, the tracker device 1 may provide the page number and/or chapter number on a display on the tracker device 1.

FIG. 2 shows an example of a tracker device 1 for determining progression data for one version of a literary work, whilst FIG. 3 shows an illustrative example of a database 30 comprising formatted literary data for a particular literary work (as identified by ID 34), from which progression data may be determined.

In the present illustrative example database 30 comprises a formatted literary data in an array having a plurality of hash values in the index 32, wherein each individual hash value in the index 32 corresponds to a position of a portion of text in the literary work as determined from the progression data entries in the corresponding rows (depicted as “Page No.” 36 & “Line No.” 38). As will be appreciated, in some embodiments the database may be generated by the tracker device from abstract literary data based on instruction(s), rule(s) and/or policy(ies) in storage.

In further embodiments the formatted literary data may be pre-calculated and stored in storage circuitry at the tracker device 1. Such functionality may be particularly useful for devices that have limited storage or processing capabilities. In embodiments, the tracker device may generate an input digest by processing the tracker position data using a transformation algorithm (e.g. MD5, SHA1, etc.).

When there is a “hit” i.e. when an input digest matches a hash value in the index 32 the progression data entries in the rows to which the hash value corresponds can be determined to be the progression data.

The determined progression data may be stored in storage at the tracker device 1 and when the user subsequently requests the progression data (e.g. by pressing a button on the tracker device), the tracker device 1 can display the progression data (e.g. page number, line number from the rows etc). to the user. When there is a “miss”, i.e. when an input digest does not match a hash value in the index 32, the tracker device 1 may repeat processing of the tracker position data. When the input digests continue to result in misses, a different transformation function may be used, with the resulting digests generated compared with hash values in a further database comprising formatted literary data for the same particular literary work. Such additional transformation functions may be stored at the tracker device or may be requested from a further apparatus.

Additionally, or alternatively, if the digests continue to miss, the user may be alerted, via the tracker device 1 that progression data could not be determined, and the user requested to capture a new image or recording or download an updated database for the version of the literary work which the user is reading. Alternatively, the tracker device 1 may transmit the tracker position data to a remote apparatus for processing thereat as will be described in greater detail below.

In embodiments the tracker device 1 may be dedicated to a particular version of a literary work and may only be capable of determining progression data for that particular literary work. As depicted in FIG. 3, the literary work may be identified by a version identifier (ID) 34, which in the present illustrative example is an international standard book number (ISBN) identifier, although the claims are not limited in this respect, and the version identifier may, additionally or alternatively include one or more of: a Digital Object Identifier (DOI) and International Standard Serial Numbers (ISSN); universal resource locator (URL), although this list is not exhaustive. The tracker device 1 may be provisioned with the abstract literary data for the particular literary work for example by a manufacturer, a publisher, a bookstore owner, or a user, or may access or request abstract literary data via a remote apparatus. In other embodiments, the tracker device 1 may be provisioned with the formatted literary data for the version of the literary work for example by a manufacturer, a publisher, a bookstore owner or a user, or may access or request the formatted literary data via a remote apparatus.

In other embodiments the tracker device 1 may be capable of determining progression data for a plurality of literary works and for one or more versions of each literary work, whereby databases comprising abstract literary data for the different literary works are provisioned on the tracker device 1, from which the tracker device 1 can generate formatted literary work for each version.

Such functionality may be beneficial when a user is reading different versions of the same literary work and provides for synchronisation or tracking of the progression data across the different versions and/or for different tracker devices.

As illustratively shown in FIG. 4 a user may be reading both a physical version 40 and a digital version 42 of the same literary work and may want to track or synchronise progress across the different versions. For example, when the user ceases reading a physical version of the literary work and subsequently begins reading a digital version of the same literary work the user will want to determine the point where he ceased reading the physical version, so he can start reading the digital version at that point.

As such, when a user ceases to read a first version of a literary work (e.g. a softcover version), the tracker device 1 may determine and store the progression data for each of the different versions as described above. When the reader begins reading a second version of the literary work and requests the progression data, the tracker device will translate the determined progression data for the first version to progression data for the second version and display the progression data for the second version in a user understandable format e.g. text, sound, braille etc.

In examples the user may identify the version he is reading by pressing a button on the tracker device corresponding to the particular literary work or selecting the particular literary work via an interface on the tracker device. In a further illustrative example, the user may take an image or read out a version identifier (e.g. an ISBN) from which the tracker device performs OCR or SRS to determine the correct version. It will be appreciated that the examples by which the tracker device will determine the progression data is exemplary only and the claims are not limited in this respect.

In the illustrative example of FIG. 5a, database 50 comprises formatted literary data for a plurality of versions of a particular literary work (as identified by IDs 54a, 54b). The database 50 is similar to the database 30 depicted in FIG. 3, whereby the progression data entries include page and line numbers for a softcover version of the literary work and further comprises location numbers for a digital version of the literary work, whereby the progression data for each version may be determined from input digests generated at the tracker device 1.

In the illustrative example of FIG. 5a, the tracker device 1 may translate progression data for one version into progression data for one or more further versions, whereby the progression data may be determined based on or in response to the tracker position data as described above.

As such, in an embodiment, the tracker device may determine the progression data for all versions of the literary work and store the determined progression data for each version in storage. When a user subsequently requests the progression data for a particular version (e.g. by including the version identifier in the request), the tracker device will provide the progression data for that version to the user (e.g. in a user understandable format).

In a further illustrative example, the tracker device may only determine the progression data for one version, and subsequently translate the progression data for that version to determine corresponding progression data for a different version. As depicted in FIG. 5b, the version identified at column 62 is a softcover version of Don Quixote; the version identified at column 64 is a hardcover version of Don Quixote; whilst the version identified at column 66 is a Kindle® digital book version of Don Quixote. As such, when progression data (e.g. page number) for one of the versions is determined, the tracker device may subsequently translate that progression data into progression data for a different version. As such, the tracker device 1 may store the progression data for one version and translate the progression data for a different version as requested by a user.

Whilst progression data entries are depicted as page numbers in FIGS. 5a & 5b, the claims are not limited in this respect and the progression data entries in the database 60 may comprise paragraph numbers, line numbers, chapter numbers, location number (for a digital version), audio time (for audiobook version) etc.

In some embodiments, the user may wish to highlight certain portions of a literary work as a point of interest (POI) and/or make notes about a POI whilst continuing to read the literary work.

As such, the user may cause the tracker device 1 to generate tracker position data for a POI during the course of reading a literary work, whereby the POI may comprise a word, a line, a paragraph, a page, a chapter, a figure or drawing, location number, audio time etc, and whereby the tracker device generates the sensed data and determines the position of the POI in a substantially similar manner as deriving the progression data as previously described. The user may also, e.g. via an input, indicate that the tracker position data is for a POI (e.g. via a user input) and the tracker device may then add a POI identifier in the tracker position data. The tracker device may then store the POI position data in storage.

The user can then (e.g. via a button or interface on the tracker device) request that the tracker device provide the position of the POI thereto (e.g. via a display, speaker, braille terminal etc).

As such, generating tracker position data for a POI may be seen as analogous to highlighting a physical book with a highlighter pen or highlighting a digital version with a highlighter function thereon.

In embodiments the user may request a synonym or antonym for a POI comprising a word or phrase, whereby the tracker device may comprise, or have access to, a thesaurus reference database to satisfy the request and return the result to the user (e.g. via a display, speaker, braille terminal etc).

Additionally, or alternatively, the user may request one or more of: a meaning, an etymology and a pronunciation for a POI comprising a word or phrase, whereby the tracker device may comprise, or have access to, a dictionary reference database to satisfy the request. In other embodiments the tracker device may transmit the request for a synonym, antonym, meaning, etymology and pronunciation from the user to a further resource to satisfy the request.

In embodiments the user may request a translation for a word or phrase POI, whereby the tracker device may comprise or have access to a translation database.

In embodiments the user may, via a keyboard interface on the tracker device or at a remote apparatus, generate note data linked to a particular POI, whereby the note data may comprise the user's thoughts on the POI (e.g. reminders/plot theories etc.). As such generating the note data may be seen as analogous to writing notes in the physical book with a pen or pencil.

The note data may be stored at the tracker device such that when the user subsequently requests the note data for the POI, the tracker device will provide the note data to the user via, for example, a display, a speaker, a braille terminal etc.

In some embodiments user progress along different paths through a literary work may be tracked. As an illustrative example, a first path may comprise the user reading pages in sequential order from start to finish, whereby the user will cause the tracker device to generate sensed data from which the progression data can be determined. The user can then pick up the literary work (the same version or different version), and the tracker device will indicate where the user previously ceased reading.

In other embodiments the user may read the pages in non-sequential order. As an illustrative example, the literary work may provide the user with decision points, whereby the user branches to one path in response to a first decision (e.g. “if you think he is guilty jump to page 112”) or branches to a different path dependent on a second decision (e.g. “if you think he is innocent jump to page 240”). Each path may have further decision points therealong to provide the user with a different reading experience each time the literary work is read. Therefore, the user may indicate that a particular decision point is a POI to maintain visibility of the decision point such that the user can review the decision points should it change its mind and chose to revert to a different decision point.

In a further illustrative example, law texts (e.g. “The Annotated European Patent Convention” published by Wolters Kluwer) may have articles which reference different articles or rules and vice versa, whereby the user, on reading a particular article may be required to read one or more rules. Therefore, the user may indicate that a particular article is a POI, and the tracker device will provide an indication of related POI(s) e.g. rules and/or articles in the literary work which may be determined from a database provisioned on the tracker device 1 or an different apparatus.

Whilst the embodiments above generally describe the tracker device 1 generating and processing device data (e.g. tracker position data) to determine the progression data, the tracker device 1 may, additionally or alternatively, transmit device data to one or more apparatuses to process the device data and determine the progression data. For example, the tracker device 1 may transmit the device data to a remote apparatus when the tracker device does not have the capabilities (e.g. storage, processing power, power, time etc.) to determine progression data for one or more literary works, or where the tracker device does not have the necessary instruction(s), rule(s) and/or policy(ies) to translate the abstract literary data to formatted literary data. Such a remote apparatus may comprise hardware/software components to determine progression data based on or in response to device data received from the tracker device 1.

As an illustrative example of the tracker device transmitting the device data to a further apparatus, FIG. 6a shows an example of tracker device 1 in communication with apparatus 72, which in the present illustrative example is an edge processing device (edge device), whereby tracker device 1 transmits (e.g. via Wi-Fi, NFC or Bluetooth etc.) the tracker position data to the edge device 72, which may comprise, a mobile phone, tablet, personal computer, a digital book (e.g. Kindle eBook) or the like.

In embodiments, the edge device 72 is provisioned with the abstract literary data and translates the abstract literary data to formatted literary data based on e.g. instruction(s), rule(s) and/or policy(ies). On receiving the tracker position data from the tracker device 1, the edge device 72 processes 73 the tracker position data and determines the progression data as set out above and takes an appropriate action in response thereto, such as transmitting the progression data to the tracker device 1 or transmitting a command communication to the tracker device to instruct the tracker device to take a specific action (e.g. to display certain text, or emit a sound).

In a further embodiment, FIG. 6b illustratively shows an example of tracker device 1 in communication with apparatus 74, which in the present example is a service 74, whereby tracker device 1 transmits device data (e.g. via Wi-Fi, NFC or Bluetooth etc.) to a service 74 for processing thereat.

In embodiments, the service 74 is provisioned with the abstract literary data and translates the abstract literary data to formatted literary data based on e.g. instruction(s), rule(s) and/or policy(ies) stored thereat. On receiving the tracker position data from the tracker device 1, the service 74 processes 73 the tracker position data and determines the progression data and takes an appropriate action in response thereto.

In a further embodiment, FIG. 6c illustratively shows an example of tracker device 1 in communication with service 74 via edge device 72, whereby tracker device 1 generates the tracker position data and transmits (e.g. via Wi-Fi, NFC or Bluetooth etc.) the device data to edge device 72, which may process 73 the device data and/or may transmit the device data to service 74 for processing to determine the progression data and to perform an appropriate action. In embodiments, the edge device 72 and/or service 74 are provisioned with the abstract literary data and formatted literary data as described above.

The apparatuses (e.g. edge device/service) may also subject the device data from the tracker device and/or progression data to analysis by a deep learning algorithm or hivemind analysis, and to take an action in response to such analysis.

Whist FIGS. 6a-6c illustratively show examples of edge processing devices and services, these configurations are exemplary only and the claims are not limited in this respect and one or more other apparatuses (e.g. gateway devices, routers, servers etc) may be arranged in communication with the tracker device 1, the edge device 72 and/or the service 74 to provide the described functionality.

As will be appreciated, when the edge device 72 or service 74 processes the tracker position data and determines the progression data, the circuitry (e.g. processing, power, circuitry) on the tracker device can be simplified in comparison to when the tracker device is required to process the tracker position data to determine the progression data. As will further be appreciated, the edge device or service may have more (or more powerful) capabilities (e.g. processing, storage, power) than the tracker device and can therefore provide for faster functionality in comparison to the tracker device.

As an illustrative example, a tracker device that generates tracker position data but does not process the tracker position data to determine progression data would require I/O circuitry to generate the tracker position data, and communications circuitry to transmit the tracker position data to the edge device/service, but the processing, storage and power requirements may be reduced in comparison to when the tracker device is required to process the tracker position data to determine the progression data.

As an illustrative example, the service may have access to an increased number of abstract literary data databases to enable the service determine progression data for a greater number of literary works, or greater numbers of versions of literary works, in comparison to the tracker device.

As a further illustrative example, when the tracker device cannot determine the progression data (e.g. due to corruption of tracker position data), the tracker device may request for the user to generate new tracker position data whilst the service may use different techniques which the tracker device is not capable of performing (e.g. due to power, processing or storage constraints). As an illustrative example, when generating input digests using a particular hash function and there is a “miss”, i.e. when an input digest does not match a hash value in an index in a database, the service may use a different transformation function, or may perform the transformation function on a different portion of text, and compare the resulting digests with values in databases which are not provisioned on, or which are not available to the tracker device 1.

The apparatuses remote from the tracker device may communicate with the tracker device to cause the tracker device to perform one or more functions. As an illustrative example, the edge device and/or service may transmit command data to the tracker device to instruct the tracker device to perform an action. Such an action may be for the tracker device to display data to the user (e.g. formatted position data, POI data, advertising data, suggested related literary works, a warning) or to perform an update.

Whilst the examples above generally describe displaying progression data in a user understandable format on an output circuit comprising a display at the tracker device 1, the claims are not limited in this respect, and the determined progression data may be provided to the user in any suitable manner. For example, the tracker device 1 may comprise an output circuit comprising a speaker so as to provide the determined progression data to the user in a user understandable format via the speaker (e.g. using text-to-speech software). In a further example, the output circuit at the tracker device may comprise a braille terminal so as to provide the progression data to a blind user.

Furthermore, whilst the tracker device may be provided with output circuitry to provide the formatted position data to the user, such circuitry is optional because the edge device (e.g. a mobile phone, laptop, tablet etc) or service could itself provide the determined progression data to the user thereat, or the edge device or service could transmit the determined progression data to a further device associated with the user to provide the progression data to that user.

As described above, the user may read different versions of the same literary work at different times. In some embodiments the user may use one or more tracker devices to track user progression.

As an illustrative example shown in FIG. 6b, the user may use a tracker device 1 which is separate from a physical literary work to track progression in the physical literary work, whilst a digital version 76 of the literary work may incorporate a tracker device application 1′ running thereon to provide some or all of the functionality of the tracker device described above.

When the user reads the physical version of a literary work and the digital version of the literary work at different times over a period of time then tracking progression data from the different versions allows the user to know where he last ceased reading the literary work, regardless of which version he is currently reading or which device generates the tracker position data.

FIG. 7a illustratively shows a block diagram showing example data at the tracker device 1 and apparatus 74 to provide for tracking progression data over different versions of a literary work at the apparatus 74. It will be appreciated the data depicted are exemplary only and that not all data is depicted in FIG. 7a.

As above, a user reading a physical version may cause the tracker device to generate sensed data representative of a position in the literary work (e.g. due to stopping reading at a particular page or marking a POI).

The tracker device 1 transmits tracker position data to the apparatus, whereby the tracker position data comprises the sensed data, and further comprises version data relating to the version of the literary work from which the sensed data was generated. The version data may comprise a version identifier for the literary work and, for a digital version, may further include a device identifier (e.g. Model Number/type), and may further include details of the device parameters/settings (e.g. font size, font type, %zoom) implemented on the device at the time the user generated the sensed data. The tracker position data may also include a time identifier such as a timestamp for the time one or more of the sensed data, the version data and the tracker position data is generated.

The tracker device may also transmit user data relating to the user, such as authentication data (e.g. a certificate, cryptographic keys, password etc.) to allow the apparatus to verify that the user is authorised to communicate therewith (e.g. a user subscription is up to date, the user is trusted etc.). The apparatus may verify, using user data provisioned thereon, that the user is authorised to communicate therewith based on or in response to the received user data.

The apparatus 74 may translate the abstract literary data into formatted literary data for one or more versions of the literary work (e.g. the physical literary work, digital version), whereby the apparatus may use instruction(s), rule(s) and/or policy(ies) in storage to translate the abstract literary data into formatted literary data for one or more versions of the literary work. In other embodiments the formatted literary data for one or more versions may be pre-provisioned at the apparatus so it does not need to generate the formatted literary data for those one or more versions, thereby reducing processing requirements.

The apparatus 74 may determine progression data for each version from the formatted literary data based on or in response to the tracker position data received from the tracker device 1.

The apparatus 74 may transmit the progression data to the tracker device 1, whereby the tracker device 1 will determine a user understandable format therefrom. Additionally, or alternatively, the apparatus may determine the user understandable format by which the tracker device will provide the progression data to the user and transmit command instruction to the tracker device 1 to, for example, display certain text on a display or emit a certain sound. For a digital version the apparatus may take account of the digital format data to determine the progression data and/or formatted position data and may further take account of device settings or parameters (e.g. as defined in the version data) to cause the progression data to be provided in a user understandable format.

In some embodiments the sensed data may relate to a POI, and the apparatus will determine the formatted position data for the POI and transmit formatted position data for the POI to the device. The POI data may also include note data relating to the POI. This note data may be transmitted to the apparatus and stored thereat, or the note data may be stored at the tracker device 1.

As set out above, a user may generate tracker position data for multiple versions of literary works, and the apparatus can be used to determine the progression data for each version, and further determine which progression data is the most suitable to provide to the user to ensure that the most suitable progression data is identified.

In embodiments the apparatus may generate a data structure representative of the user progression through one or more versions of the literary work, whereby the apparatus may make decisions based on or in response to such a graph, such as to determine which progression data is the most suitable to provide to the user.

As an illustrative example shown in FIG. 7b, graph 90 is representative of a user position in two versions of a literary work (V1 & V2), whereby vertices 92a-d are representative of positions in the literary work (e.g. determined in response to tracker position data for the respective versions from one or more tracker devices). The apparatus 74 may determine that the vertice representative of the most recently determined position is determined to be the most suitable progression data (depicted as vertice 92d in FIG. 7b).

The apparatus 74 may transmit the progression data for that version to the tracker device, whereby the tracker device 1 will determine the user understandable format by which to provide the formatted position to the user. Additionally, or alternatively, the apparatus may transmit command instructions to the tracker device 1 to cause the tracker device to provide the formatted position data in a user understandable format.

As a further illustrative example shown in FIG. 7c, graph 94 is representative of user position in three versions V1-V3 of a literary work, whereby vertices 96 are representative of positions in the literary work (e.g. determined in response to tracker position data for the respective versions from one or more tracker devices) and plotted for position (P) on the Y-axis versus time (t) on the X-axis.

In an example, the apparatus may determine that the vertice 96a at P_{MAX} is determined to be the most suitable progression data. Although there are vertices corresponding to tracker position data received later at the apparatus, taking the furthest progression through the literary work as the most suitable progression data means that tracker position data inadvertently generated can be ignored.

For example, the tracker position data resulting in the position represented at 96b is the latest generated position, but is the earliest progression and may have been inadvertently generated by V3, which may have been powered on after a period of time and the tracker position data generated when the user was at an earlier page in the literary work than currently at. As such, determining vertice 96a as the most suitable progression data means that the progression data determined in response to the latest tracker position data from V3 can be ignored.

In a further example, some literary works are not required to be read in sequential page order, so determining the vertice at P_{MAX} to be the most suitable may also result in the apparatus providing incorrect progression data to the user. As such, in some cases taking the vertice at t_{MAX} to be the most suitable user progression data may be more appropriate (depicted as node 96b in FIG. 7c).

The functionality described above also provides for synchronisation between different versions of the same literary work across one or more apparatuses, whereby a user reading two different versions of the same literary work will be provided with the most suitable progression data for the version the user chooses to read at any particular time.

It will also be appreciated that the apparatus may provide the functionality described above for two or more users, such that the apparatus can track the progress of different users through one or more literary works, and for different versions of those literary works. In embodiments each user may be identified by a user identifier which may be included, for example, in the tracker position data.

FIG. 8a illustratively shows a flow diagram of process 100 in which a tracker device generates tracker position data from which progression data may be determined.

At S100, the process starts.

At S102 a user reading a literary work (e.g. a book, a magazine etc.) may cause a tracker device to generate tracker position data comprising, for example, one or more of: sensed data, version data and POI data.

The tracker device 1 may process the tracker position data or may transmit the tracker position data to a remote apparatus for processing the tracker position data thereat (e.g. when the tracker device does not have sufficient capabilities such as processing, power, storage capabilities etc.), whereby an address identifier of the remote apparatus(es) to which the tracker position data is transmitted may be provisioned in storage circuitry on the tracker device (e.g. at manufacture or during a registration process with a remote apparatus).

At S104, when the tracker device determines that it should process the tracker position data to determine progression data, the tracker device at S106 processes the tracker position data. As set out above, processing the tracker position data may comprise performing OCR and/or SRS. Processing the tracker position data may also comprise performing a transformation function to generate an input digest and matching the digest to values in a formatted literary data database, although the claims are not limited in this respect.

At S104, when the tracker device determines that it should not process the tracker position data, the tracker device at S107 transmits the tracker position data to a remote apparatus, which may comprise an edge device (e.g. a phone, a laptop, a tablet, a digital book etc.) or a service.

At S108, when the tracker device processes the tracker position data but does not derive progression data (e.g. because the tracker position data is corrupt) the tracker device at S110 determines whether or not to transmit the tracker position data to the remote apparatus.

When, at S110, the tracker device determines not to transmit the tracker position data to a remote apparatus, then at S111 the tracker device determines whether to reprocess the tracker position data to determine the progression data. When the tracker device determines to reprocess the tracker position data the process returns to S106, whilst, in the present illustrative example, when the tracker device determines not to reprocess the tracker position data the tracker device requests the user to regenerate the tracker position data (e.g. via a message on a display, a sound, a light, a braille terminal).

When, at S110, the tracker device determines to transmit the tracker position data, then, as at S107, the tracker device transmits the tracker position data to the remote apparatus.

At S108 when the tracker device processes the tracker position data and derives the progression data from the tracker position data the tracker device at S112 stores the progression data in storage circuitry.

At S114 a user requests the progression data for a particular version of a literary work (e.g. via an interface on the tracker device), and at S116 the tracker device provides the progression data to the user in a user understandable format (e.g. via a display, a speaker, a braille terminal etc.).

FIG. 8b illustratively shows a flow diagram of a process 200 in which at S118 the apparatus processes the tracker position data. As set out above, determining the progression data may comprise identifying a position in abstract literary data for the literary work and translating that to a position in formatted literary data for a version identified in the tracker position data. Determining the progression data may also include generating one or more data structures (e.g. graphs) from which the most suitable progression data can be determined.

At S120, the remote apparatus transmits the progression data to the tracker device, although this is optional and the remote apparatus may instead cause another apparatus (e.g. a mobile phone associated with the user) to provide the progression data to the user (e.g. via a display, a sound, a light, a braille terminal at the another apparatus), or the remote apparatus may transmit other data such as formatted position data or a command instruction to the tracker device.

At S122, the process ends.

The techniques set out above means that a tracker device and/or an apparatus remote therefrom can track user progression through one or more versions of a literary work and can also synchronise user progression across the different versions and for different tracker devices. The determined user progression can then be presented to the user on a device associated with the user.

Embodiments of the present techniques provide a non-transitory data carrier carrying code which, when implemented on a processor, causes the processor to carry out the methods described herein.

The techniques further provide processor control code to implement the above-described methods, for example on a general-purpose computer system or on a digital signal processor (DSP). The techniques also provide a carrier carrying processor control code to, when running, implement any of the above methods, in particular on a non-transitory data carrier or on a non-transitory computer-readable medium such as a disk, microprocessor, CD- or DVD-ROM, programmed memory such as read-only memory (firmware), or on a data carrier such as an optical or electrical signal carrier. The code may be provided on a (non-transitory) carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

Computer program code for carrying out operations for the above-described techniques may be written in any combination of one or more programming languages, including object-oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer databases to, when loaded into a computer system or network and operated upon thereby, enable said computer system to perform all the above-described method.

It will be understood that, although the terms first, second, etc. may be used herein to describe various features, these features should not be limited by these terms. These terms are only used to distinguish one feature from another. Furthermore, the term “and/or” includes any and all combinations of one or more of the associated listed items.

Furthermore, the terminology used herein is for the purpose of describing embodiments only and is not intended to be limiting. For example, as used herein the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In the preceding description, various embodiments of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. An apparatus for determining user progression data in a literary work, the apparatus comprising:
a database comprising formatted literary data for two or more versions of a literary work; and
circuitry to:
process tracker position data for a first version of the one or more versions; and
determine, from formatted literary data for the two or more versions, progression data for a second version of the literary work based on or in response to the tracker position data for the first version.

2. The apparatus of claim 1, further comprising:
a database including abstract literary data for the literary work.

3. The apparatus of claim 2, further comprising:
circuitry to convert the tracker position data for the first version to an abstract position in the abstract literary data.

4. The apparatus of claim 3, further comprising:
circuitry to translate the abstract position to a formatted position in the respective formatted literary data for the first and second versions.

5. The apparatus of claim 4, wherein the progression data for the second version comprises a formatted position in the formatted literary data of the second version.

6. The apparatus of claim 5, further comprising communication circuitry to transmit one of progression data for the first version, the progression data for the second version, and a command communication to a remote device or apparatus.

7. The apparatus of claim 6, further comprising circuitry to determine which of the progression data for the first version and the progression data for the second version is the most suitable to send to the remote device or apparatus.

8. The apparatus of claim 7, further comprising circuitry to:
generate a data structure comprising one or both of the progression data for the first version and the progression data for the second version;
determine, from the data structure, which of the progression data for the first version and the progression data for the second version is the most suitable to send to the remote device or apparatus.

9. The apparatus of claim 1 further comprising output circuitry to output the progression data in a user understandable format.

10. The apparatus of claim 1, wherein the tracker position data comprises sensed data relating to a position in the first version of the literary work.

11. The apparatus of claim 10, wherein the sensed data comprises one or more of:
machine-encoded text, a sound wave, an electrical characteristic, a weight of a page, an image, a code.

12. The apparatus of claim 1, comprising a database comprising user data for a plurality of users, and to determine progression data for one or more of the users based on or in response to tracker position data received from the one or more users.

13. (canceled)

14. A method of determining user progression in a literary work, the method comprising:
processing, at a first apparatus, tracker position data for a first version of a literary work;
determining, from formatted literary data for two or more versions of the literary work, progression data for a second version based on or in response to the tracker position data for the first version.

15. The method of claim 14, further comprising:
converting the tracker position data for the first version to a first abstract position in abstract literary data at the first apparatus.

16. The method of claim 15, further comprising:
translating the first abstract position to a formatted position in the formatted literary data for the first version, wherein the formatted position in the formatted literary data for the first version is determined to be progression data for the first version.

17. The method of claim 15, further comprising:
translating the first abstract position to a formatted position in the formatted literary data for the second version, wherein the formatted position in the formatted literary data for the second version is determined to be the progression data for the second version.

18. The method of claim 14, further comprising:
receiving, at the first apparatus, the tracker position data.

19. The method of claim 4, further comprising:
transmitting, from the first apparatus to a second apparatus, the determined progression data for the second version.

20. The method of claim 14, further comprising, displaying the determined progression data for the second version to a user in a user understandable format.

21. (canceled)

22. (canceled)

23. (canceled)

24. (canceled)

25. (canceled)

26. (canceled)

27. (canceled)

28. (canceled)

29. A non-transitory computer readable storage medium comprising code which when implemented on a processor causes the processor to carry out the method of claim 14.
